(19) United States
(12) Patent Application Publication
(10) Pub. No.: US 2006/0174127 A1
(43) Pub. Date: Aug. 3, 2006

(54) Network access server (NAS) discovery and associated automated authentication in heterogenous public hotspot networks

(76) Inventors: Asawaree Kalavade, Stowe, MA (US); Sashidhar Annaluru, Santa Clara, CA (US)

Correspondence Address: LAW OFFICE OF DAVID H. JUDSON, 15950 DALLAS PARKWAY, SUITE 225, DALLAS, TX, 75248, US

(21) Appl. No.: 11/266,980

(22) Filed: Nov. 4, 2005

Related U.S. Application Data
(60) Provisional application No. 60/625,465, filed on Nov. 5, 2004.

(51) Int. Cl. H04L 9/00

(52) U.S. Cl. 713/176

(57) ABSTRACT

Automated HTTP-based user authentication in a public WLAN environment is facilitated across heterogeneous network access servers (NASs). Each of a set of network access servers has a given authentication protocol, and these protocols typically differ from one another. According to the invention, each authentication protocol has a unique “signature.” According to the invention, a “smart” client that is executable on a given wireless device seeking access to the public WLAN environment is provided with a set of signatures. These signatures are used by the client to determine the appropriate access protocol to use with respect to a given NAS that is controlling access to the WLAN. The client may also have the capability of discovering an unknown authentication protocol “on-the-fly” as it attempts to obtain wireless access. The set of signatures is updated in the client from time-to-time without requiring the client software to be recompiled. The present invention thus provides a generic mechanism by which a client can work with any NAS.

This application is based on and claims priority from provisional application Ser. No. 60/625,465, filed Nov. 5, 2004.

### BACKGROUND OF THE INVENTION

This application contains subject matter that is protected by copyright.

1. Technical Field

The present invention relates generally to WAN mobility technologies and services.

2. Description of the Related Art

Wireless LAN services are increasingly being offered in public venues. A typical method for user authentication in public venues is based on “HTTP intercept.” In this method, the user starts a HTTP session at a public venue. This session is intercepted by a Network Access Server (NAS), which queries the user for authentication credentials. The authentication information is exchanged between the user and the NAS via HTTP messages. Once authenticated, the NAS passes the user's normal HTTP traffic. To provide a consistent branded user experience, there is an increasing demand from service providers to provide a “smart client” that programmatically provides HTTP-based authentication. While the HTTP-based mechanism is fairly straightforward, there is no industry-specified method or standard for this authentication exchange. Protocols, such as WISPr (defined by the Wi-Fi Alliance), attempt to standardize the NAS authentication, but conforming implementations are not widely deployed. As a result, each NAS uses its own HTTP-exchange for querying the user for authentication credentials. This becomes especially problematic in public WLAN networks, because different venue owners tend to have different architectures with different equipment from vendors. Thus, providing an automated authentication experience is not possible with today's myriad of NAS architectures.

The following description provides additional details regarding the prior art. A wireless hotspot is illustrated in FIG. 1. The hotspot 100 comprises one or more access points (each an “AP”) 102 connected to a Network Access Server (NAS) 104. The NAS 104 is connected to the Internet through one or more routers or switches 106. When the user at a hotspot wishes to connect to the Internet, the user launches the browser and specifies (directly or indirectly) a desired page URL. The NAS redirects the user's browser to a start page, typically by sending a HTTP REDIRECT message to the browser. The start page contains a form through which a user may enter a given credential (e.g., userid and password), or a link to a web page that includes such a form. After the user then submits his or her credentials using the form, the NAS performs user authentication, typically by using a RADIUS server. RADIUS is an IETF-defined client/server protocol and software that enables remote access servers to communicate with a central server to authenticate dial-in users and authorize their access to the requested system or service. When the RADIUS server sends back an ACCEPT, the NAS redirects the user's browser to either a welcome page provided by the hotspot service provider, or to the original URL that the user tried to access.

The above-described mechanism works well with a web browser because the browser simply presents the HTTP message to the user, and it is the user's responsibility to navigate through the web page to find out what to do to log in to the network. Recently, there have been several attempts to automate this process through the use of a so-called “smart” client, which performs navigation (on behalf of the user) automatically. In theory, a smart client provides a good solution to the problem of authenticating a user at a hotspot, but there is no available protocol that is followed by all available NAS products. Until the industry standardizes on a protocol and every NAS uses it, building a smart client that works with all the NAS types is a challenging task.

The present invention addresses this problem.

### BRIEF SUMMARY OF THE INVENTION

Automated HTTP-based user authentication in a public WLAN environment is facilitated across heterogeneous network access servers (NASs). Each of a set of network access servers has a given authentication protocol, and these protocols typically differ from one another. According to the invention, each authentication protocol has a unique “signature.” According to the invention, a “smart” client that is executable on a given wireless device seeking access to the public WLAN environment is provided with a set of signatures. These signatures are used by the client to determine the appropriate access protocol to use with respect to a given NAS that is controlling access to the WLAN. The client may also have the capability of discovering an unknown authentication protocol “on-the-fly” as it attempts to obtain wireless access. The set of signatures is updated in the client from time-to-time without requiring the client software to be recompiled. The present invention thus provides a generic mechanism by which a client can work with any NAS.

According to the invention, the authentication used by each type of NAS is captured through a unique signature. In particular, the signature preferably captures protocol identifiers including, for example, host name, URL, and login and password formats. In one embodiment, the signature is captured programmatically through a tool that captures the HTTP responses and requests as the user goes through the sequence manually. Different NAS signatures are bundled into a single signature file that is used by the client. The signature file preferably comprises simple ASCII text. Typically, the signature capture process is performed relatively infrequently and can be triggered by the user, a service provider, or some other entity. The signature capture process can also be automatically started by the client when the client sees that an authentication has failed using existing signatures. When a new NAS is identified, the new signature file can simply be updated to the client without requiring a re-compilation of the client. At runtime, the client sequences through the signature file to see which signature headers match. Once the appropriate signature is selected, the client programmatically responds to the HTTP requests related to the authentication sequence.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a simplified representation of a prior art hotspot;

FIG. 2 is a call flow diagram that illustrates a typical HTTP intercept-based authentication mechanism for a smart client;

FIG. 3 illustrates how NAS discovery works using a signature file;

FIG. 4 illustrates how the client can find which NAS signature to use for a specific NAS in real-time;

FIG. 5 illustrates the techniques of the present invention may be implemented either with client-based NAS discovery or server-based NAS discovery; and

FIG. 6 illustrates a server-based two-phase authentication scheme in which the NAS discovery technique may be used.

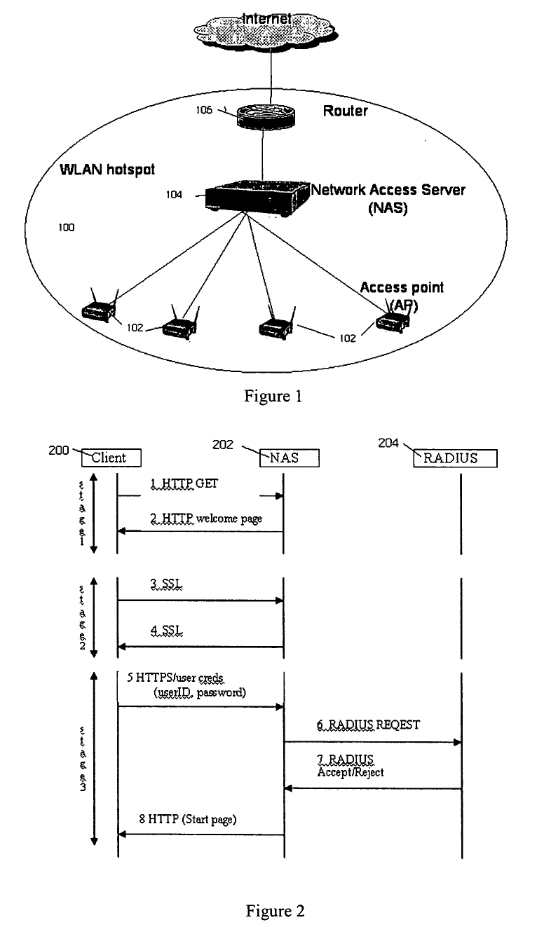

### DETAILED DESCRIPTION OF AN ILLUSTRATIVE EMBODIMENT

The present invention may be implemented in a WLAN or other network environment. WLAN refers to a wireless local area network, typically based on IEEE 802.11 technology. In a representative embodiment, it is assumed that an end user accesses the WLAN with an 802.11-compliant mobile device, such as a laptop, a cell phone, a PDA with a GPRS NIC, or the like. Client software is downloadable to the user's device in any conventional manner to provide a “smart client.” The client software may be original equipment or otherwise native to the mobile device. While the present invention may be implemented in a smart client, this is not a limitation, as a server-centric embodiment is also described below.

By way of additional background, FIG. 2 is a call flow diagram that illustrates a typical HTTP intercept-based authentication mechanism that is used by a smart client 200. When user initiates the authentication process on the smart client, the user's browser sends a HTTP GET request to an arbitrary but valid URL (msg #1). A HTTP GET message looks as follows:
GET / HTTP/1.1\r\n\r\n.

If the user has already been logged into this network, then the HTTP GET request is passed to the host in the URL and the host will reply back to the client. If, however, the user is not logged in, then the NAS 202 intercepts the HTTP message and sends back a HTTP REDIRECT message (msg #2). (Alternatively, the smart client may be configured to issue the HTTP redirect itself). A typical HTTP REDIRECT message is as follows:
HTTP/1.1 302 Moved\r\n
Location: https://nokia1.tatarasystems.com/login user.html\r\n\r\n

After receiving the REDIRECT message, the smart client needs to send the user credentials to the host (in this case, the NAS) specified in a Location header of the REDIRECT message. It is insecure to send the user credentials in the clear; thus, the NAS may require the smart client to do a Secure Sockets Layer (SSL) connection to send the user credentials. In such case, the smart client establishes a SSL connection with the NAS (msg#3, msg#4). Although there are several message exchanges in the SSL negotiation, only two messages are shown in the diagram for illustrative purposes. Once the SSL connection is established, the smart client sends the user credentials (user name and password) to the NAS, e.g., using an HTTP POST method under the SSL protection (msg #5). A typical HTTP POST with user credentials is as follows:
POST /cgi-bin/login HTTP/1.1\r\n
Host: nokia1.tatarasystems.com\r\n
Content-Length: 24\r\n\r\n
user=abc&password=abc123\r\n\r\n

The NAS then initiates a RADIUS request to the RADIUS server (msg #6). When the RADIUS server 204 is finished verifying the user credentials, it sends either a RADIUS ACCEPT or RADIUS REJECT to the NAS (msg #7). As an indication of authentication complete and also as a response to the client's HTTP POST message, typically the NAS then sends an HTTP OK message, which optionally may contain a start page. A typical success message is as follows:
HTTP/1.1 200 OK\r\n
Date: Fri, 31 Jan 2003 23:32:27 GMT\r\n
Server: Apache/1.3.6 Ben-SSL/1.36 (Unix)\r\n
Cache-control: no-cache\r\n
Expires: Sat, 31 Jan 23:32:27 2003 GMT\r\n
Pragma: no-cache\r\n
Last-Modified: Thu, 01 Jan 1970 00:00:00 GMT\r\n
Transfer-Encoding: chunked\r\n
Content-Type: text/html\r\n\r\n
<html>\r\n
<head>\r\n
<title>Welcome</title>\r\n
</head>\r\n
rest of the HTML string
</html>\r\n\r\n
   A typical response when the user authentication has failed is as follows:
HTTP/1.1 200 OK\r\n
Date: Fri, 31 Jan 2003 23:32:27 GMT\r\n
Server: Apache/1.3.6 Ben-SSL/1.36 (Unix)\r\n
Cache-control: no-cache\r\n
Expires: Sat, 31 Jan 23:32:27 2003 GMT\r\n
Pragma: no-cache\r\n
Last-Modified: Thu, 01 Jan 1970 00:00:00 GMT\r\n
Transfer-Encoding: chunked\r\n
Content-Type: text/html\r\n\r\n
<html>\r\n
<head>\r\n
<title>Error</title>\r\n
</head>\r\n
rest of the HTML string
</html>\r\n\r\n

The messages shown above (which are merely representative) are from a network access server that does not follow a standards-based protocol, such as WISPr or Pass-One. In particular, Pass-One defines a protocol specifying a list of attributes that the NAS has to send in response to the smart client's HTTP GET and HTTP POST messages. Some of those attributes include: access mechanism type, NAS location ID, NAS's host address, protocol (HTTPS/HTTP), and URL to post the user credentials. In theory, the NAS response should be compatible with all smart clients and also with all web browsers. Because, however, web browsers do not understand these attributes, according to the protocol they are sent as HTML comments. WISPr is similar to Pass-One except that the attributes (in WISPr) are in XML format and these XML messages are embedded in the HTML text (once again as HTML comments).

The present invention provides a generic mechanism within or associated with a smart client that supports any NAS. As will be seen, the mechanism is based generally on the property that all HTTP messages are strings that can be captured deterministically as a “signature” and then matched, preferably in real-time. The present invention exploits these properties in the manner that is now described.

In particular, the invention provides a method to capture a given NAS authentication protocol in a flexible manner through signatures, a method to update the signature within the client (preferably without re-compilation), a method to discover a given NAS type by analyzing an authentication signature in real-time, and a method to authenticate a user via this NAS protocol. One feature of the invention is the ability to capture a method followed by a given NAS and to translate that method into a generic specification form, which (for convenience herein) is called a NAS signature. Generalizing, a NAS signature captures all (or substantially all of) the information necessary for a smart client to complete the HTTP intercept-based authentication and user logoff from the network. With this ability, the support of a new NAS or a new method is straightforward, and it is accomplished merely by adding a new NAS signature to the smart client. No smart client code changes are required. This is highly advantageous in terms of ease of use and reliability.

In particular, and as discussed above, an HTTP REDIRECT message that a given NAS sends contains one or more strings (separately or combined) that uniquely identify a NAS or the method followed by that NAS. This is referred to as a discovery signature. The discovery signature (for a given NAS) can be present in the HTTP header or in the HTTP body itself. For example, an HTTP redirect sent by a given vendor ABC typically will have a string “ABC” in the host name of the location header. In like manner, the NAS response to the user's authentication request also contains one or more strings that uniquely determine whether the authentication is successful or a failure. These strings are referred to as auth success signatures and auth failure signatures, respectively. A set of strings are also generated for the user logoff request, which for convenience are called logoff success signatures and logoff failure signatures, respectively. A given NAS signature captures all or substantially all of this information into a formatted signature file as described below.

A signatures file typically contains several NAS signatures describing many NAS authentication methods. A typical format of a given NAS signature may be as follows, although the following is merely representative of a syntax that may be used for this purpose. All lines starting with a ‘#’ are comments.

```
START
#NAS Discovery
    #Name of the NAS Signature
    <NAS Signature's name>
    #Number of discovery signatures
    <Number of discovery signatures>
    #Discovery Signature 1
    <discovery signature 1>
    ...
    #Number of signature strings that must not present
    <Number of signature strings must not present>
    #Signature string 1 that must not present
    <signature string must not present 1>
    ...
#Auth Procedure Section
    #Host name to POST user credentials
    <host name> or FROMLOCHDR
    #URI to do POST of credentils
    <login uri>
    #Use query string from the location header
    <YES/NO>
    #User name tag to be used
    <username tag>
    #Password tag to be used
    <password tag>
#Auth Result Section
    #Auth Result Server
    <FROMLOCHDR/NA/Host name>
    #Auth Result URI
    <auth result uri/NA/FROMLOCHDR>
    #Use query string form the location header
    <YES/NO>
    #Number of Auth Success Signatures
    <Number of Auth Success Signatures>
    #Auth Success Signature 1
    <Auth Success signature 1>
    ...
    #Number of Auth failure Signatures
    <Number of Auth Failure Signatures>
    #Auth Failure Signature 1
    <Auth Failure signature 1>
    ...
    #Number of Result Pending signature strings
    <Number of Result Pending Signatures>
    #Results Pending Signature String 1
    <Result Pending Signature String1>
    ...
    #Number of times to Poll
    <Poll count>
#Logoff procedure Section
    #Logoff host name
    <logoff host name/NA>
    #Logoff method
    <GET/POST>
    #Logoff URI
    <logoff uri>
    #Logoff query string
    <logoff query string>
#Logoff Result Section
    #Logoff Result Host
    <logoff Result host name / NA / FROMLOCHDR>
    #Logoff Result URI
    <logoff result uri / NA / FROMLOCHDR>
    #Logoff Result Use Query String
    <YES/NO>
    #Number of Success Signature Strings
    <Number of success signature strings>
    #Logoff Success Signature 1
    <Logoff Success Signature 1>
    ...
    #Number of Failure Signature Strings
    <Number of failure Signature Strings>
    #Logoff Failure Signature 1
    <Logoff Failure signature 1>
    ...
END
```

As noted above, the above is merely illustrative, as other file formats and syntax may be used.

As can be seen then, typically a given NAS signature has five sections: (1) NAS discovery, (2) authentication procedure, (3) authentication result, (4) logoff discovery, and (5) logoff result. Each of these sections is now described.

The NAS discovery section of the NAS signature preferably specifies the discovery signatures and gives the method a unique name to identify the method. The following are two examples of NAS discovery sections of two different NAS signatures.

### EXAMPLE 1

#NAS Discovery

#Name of the Signature
Vendor1_NAS
#Number of discovery signatures
2
#Discovery Signature
Vendor1
#Discovery Signature
login_user
#Number of signature strings that must not present
0

### EXAMPLE 2

#NAS Discovery

#Name of the Signature
Vendor2_NAS
#Number of discovery signatures
1
#Discovery Signature
Vendor2
#Number of signature strings that must not present
0

The authentication procedure section of the NAS signature specifies the authentication procedure for this NAS method. Thus, for example, if the NAS discovery engine discovers that the NAS is following this method, then the smart client will follow the procedure specified in this section to do the authentication.
Host name to POST user credentials: this field may have a keyword FROMLOCHDR. This keyword tells the smart client to use the host name from the location header of the REDIRECT message.
URI to POST of credentials: specifies the URI to be used to POST the user credentials.
Use query string from the location header: specifies whether to use the query string from the location header of the REDIRECT message or not.
User name tag to be used: specifies the tag to be used for sending user name.
Password tag to be used: specifies the tag to be used for sending password.

An example of an authentication procedure section is set forth below:

#Auth Procedure Section

#Host name to POST user credentials
FROMLOCHDR
#URI to do POST of credentials
/cgi-bin/login
#Use query string from the location header
NO
#User name tag to be used
user
#Password tag to be used
password

The authentication section of the NAS signature specifies the way to verify the authentication result. This section contains auth success signatures and auth failure signatures. Preferably, there are two ways to find the authentication result. In a first way, the NAS sends the result as a response to an authentication POST message. A second approach is to have the smart client poll for the result. In the latter case, the NAS sends a REDIRECT message as a response to the authentication POST.
Auth Result Server: specifies where to go to find the authentication result. If this field has a given keyword (e.g., NA), the NAS sends the result as a response to the authentication POST. If this field has another given keyword (e.g., FROMLOCHDR), then the smart client gets the auth result server name from the location header of the REDIRECT message.
Auth Result URI: specifies the URI to get the authentication result.
Use query string form the location header: specifies whether the query string from the location header of the REDIRECT needs to be used.
Number of Auth Success Signatures: specifies how many auth success signatures should present in the result to decide that the authentication is successful. The list of auth success signatures follows this field.
Number of Auth failure Signatures: specifies how many auth failure signatures should present in the result to decide that the authentication is a failure. The list of auth failure signatures follows this field.
Number of Result Pending signature strings: specifies how many result pending signatures should present in the REDIRECT message to decide that the smart client should poll for the authentication result. The list of result pending signatures follows this field.

An example of an authentication result section is set forth below:

#Auth Result Section

#Auth Result Server
NA
#Auth Result URI
NA
#Use query string form the location header
NO
#Number of Success Signature strings
1
#Success signature string 1
WELCOME
#Number of failure Signature strings
1
#Failure signature string 1
ERROR

The logoff section of the NAS signature describes the logoff procedure for this NAS method.
Logoff host name: specifies the host name to be used to send the logoff request. If this field has keyword NA, then the smart client uses the same host name it used to do authentication.
Logoff method: specifies the HTTP method type to be used to do logoff (GET/POST).
Logoff URI: specifies the URI to do logoff.
Logoff query string: specifies a query string, if any, to be used with the logoff request.

An example of the Logoff procedure section is as follows:

#Logoff procedure Section

#Logoff host name
NA
#Logoff method
GET
#Logoff URI
/cgi-bin/logoff
#Logoff query string
NA

The logoff result section of the NAS signature specifies the way to verify the logoff result. This section contains logoff success signatures and logoff failure signatures. All the fields are analogous to the authentication result section.

An example of logoff result section is as follows:

#Logoff Result Section

#Logoff Result Host
NA
#Logoff Result URI
NA
#Logoff Result Use Query String
NO
#Number of Success Signature Strings
1
#Success Signature String 1
BYE
#Number of Failure Signature Strings
1
#Failure Signature String 1
ERROR

The actual tags and headers of the NAS signature preferably are captured in any convenient manner, e.g., by running a tool that monitors the HTTP messages sent and received when the user is manually doing the authentication. By observing the HTTP messages and responses, the signature is identified.

Alternatively, the NAS signature capture process preferably is done off-line, depending on when new NAS devices are identified. One such situation is where the service provider adds a new roaming partner. In such case, the NAS of the partner's network is identified; if it does not already exist, its signature is captured. In another situation, if the client fails to programmatically connect, the client prompts the user to connect through a web page. As the user responds to the web page, the client captures the signature and incorporates it for further use.

Once the NAS signatures are captured, preferably they are combined into the NAS signature file. This file typically is a simple ASCII file, as described above. When a new NAS is added (and its signature identified), the signature file is updated and sent to the client (or an update to the existing client-supported signature file is provided). In either case, there is no need to re-compile the client itself.

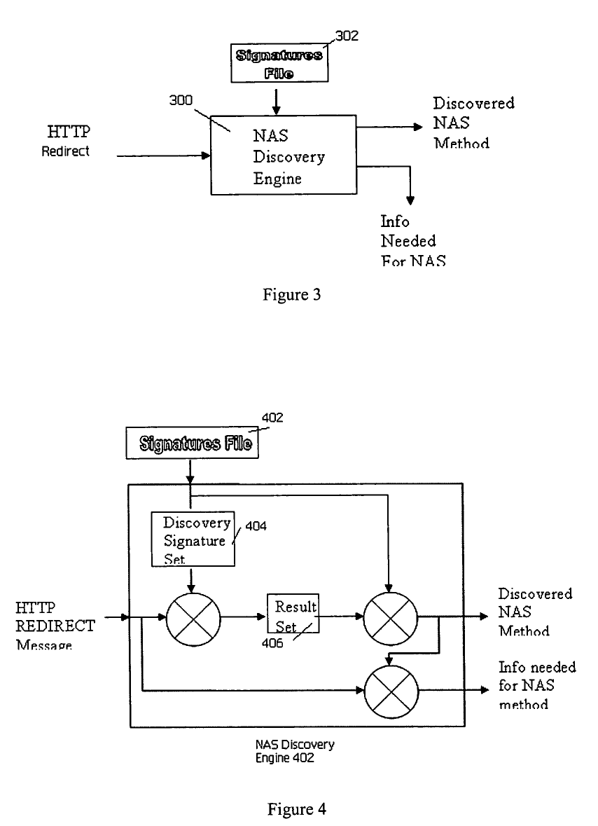

FIG. 3 illustrates how the basic NAS discovery works using the signatures file. In FIG. 3, the HTTP REDIRECT Message represents the HTTP redirect message returned by the NAS as a response to initial HTTP GET message. The signature file 302 contains a set of the NAS signatures with which the smart client operates. The client includes a NAS discovery engine 300 as either native or linkable code. The discovery engine 300 parses the HTTP redirect against the signature file to determine which NAS method specified in the signature file should be used to facilitate authentication. If a suitable NAS method exists, it is output. If no match exists, or if more information is need, the technique shown in FIG. 4 may be used.

In particular, FIG. 4 illustrates how the client may find which NAS signature to use for a specific NAS in real-time. As before, the signatures file 402 contains a set of the NAS signatures with which the smart client operates. The NAS discovery engine 400 builds a discovery signature set 404 using the signatures file. Upon receiving the HTTP REDIRECT message, the NAS discovery engine 400 builds a results set 406 corresponding to the discovery signature set, e.g., by searching for all the discovery signatures that are in the discovery set. This search engine searches for these signatures in the HTTP REDIRECT message including the HTTP header. Then, the engine checks whether the result set satisfies any of the NAS methods specified in the signatures file. Upon finding a match, the engine uses that information to parse the HTTP REDIRECT message to get all the required information for the discovered NAS method to complete the user authentication.

For example, assume the REDIRECT message is as follows:
HTTP/1.1 302 Moved\r\n
Location: https://vendor1.tatarasystems.com/login_user.html\r\n\r\n

Assume that there are two methods defined in the signatures file as shown in the above examples. Then, discovery signatures set will be {“Vendor1,” “login_user,” “Vendor2”}. After the smart client searches for these strings in the entire REDIRECT message, the result set will be {TRUE, TRUE, FALSE}. This result set satisfies the Vendor1_NAS method, so the client thus has determined that the NAS is following the Vendor1_NAS method. The client then will do the rest of the authentication following the NAS Signature named Vendor1_NAS. If no matching signature is found, the client resorts to manual authentication by prompting the user. As mentioned earlier, the signature capture program then runs in the background to capture the signature as the user enters data manually. This signature (if approved) can then be incorporated into the new signature file for subsequent use.

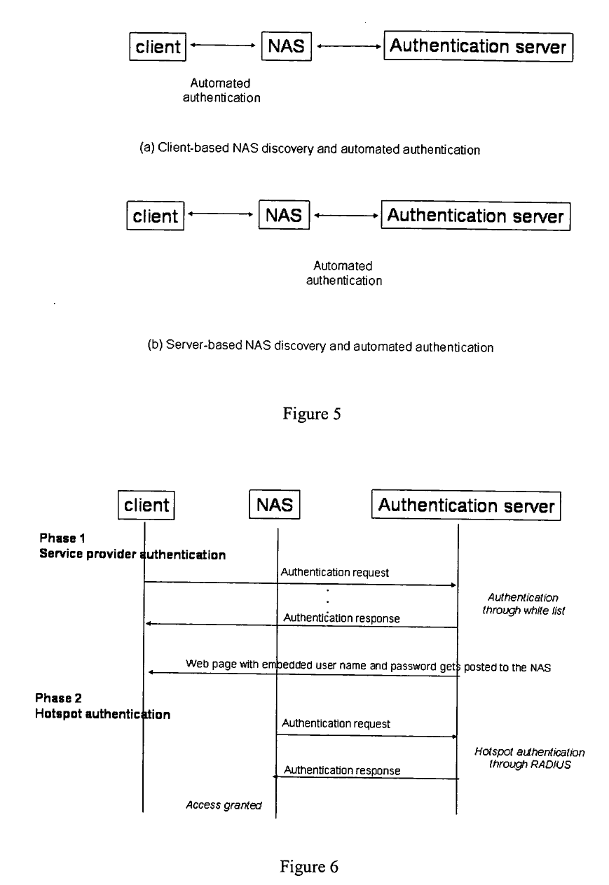

While the present invention has been described in the context of client-based NAS discovery and automated authentication, this is not a limitation of the invention. As illustrated in FIG. 5, the techniques of the present invention, in the alternative, may be implemented in a server-centric manner. Thus, the top half of FIG. 5 illustrates client-based NAS discovery and automated authentication, whereas the bottom half of FIG. 5 illustrates server-based NAS discovery and automated authentication. The following provides additional details about the server-based solution.

In particular, some service providers are provide a client-less solution, which lets a user connect at a hotspot through some other means, such as a web browser. In such case, the service provider often uses a two-phase authentication, such as illustrated in FIG. 6. In the first phase, the user is authenticated (typically over a white list) as a service provider customer and is also authorized for a certain session length. In the second phase, the WLAN hotspot operator is authorized to grant the user access for the specified period of time. Typically, the first phase is accomplished via SSL and the second phase over RADIUS. At the end of the first phase, the authentication server sends an HTML page with an embedded user ID and a one time password. This page is automatically posted to the NAS, which then continues with the authentication process as if the request came from the client. In this architecture, the server sends the HTML page formatted to fit the requirements of the NAS. For example, the user name and password fields are appropriately named depending on the NAS specifications. Thus, the same NAS signatures described above apply in this case as well. The NAS discovery itself may be done in various ways. In one approach, the NAS sends attributes (e.g., identifying the NAS type) embedded in RADIUS messages. In another approach, the NAS may be determined based, for example, on the location or service provider type. Other approaches may be used as well. In any case, the server then generates the HTML page similar to the programmatic client based authentication described earlier.

The present invention has numerous advantages. Thus, for example, a smart client can be used to programmatically authenticate the user at any public hotspot. New NAS equipment can be easily accommodated within the specification. Moreover, the NAS signature file can be updated independent of the smart client code itself, making it possible for a service provider to quickly introduce new roaming partners that support different NAS protocols.

While the above describes a particular order of operations performed by a given embodiment of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium including, without limitation, any type of disk including optical disks, CD-ROMs, and magnetic-optical disks, read-only memory (ROM), random access memory (RAM), magnetic or optical cards, or any type of media suitable for storing electronic instructions.

While given components of the system have been described separately, one of ordinary skill also will appreciate that some of the functions may be combined or shared in given instructions, program sequences, code portions, and the like.

Having described our invention, what we now claim is as follows.

1. A method to facilitate automated user authentication in a wireless local area network (WLAN) environment, comprising:
for each of a set of network access servers, generating a signature uniquely associated with an authentication protocol used by the network access server;
at a wireless device, storing, as a signature file, a set of one or more signatures;
in response to an attempt by the wireless device to authenticate to a given network server using a given authentication protocol, determining whether a signature associated with the given authentication protocol matches a signature in the signature file;
if the signature associated with the given authentication protocol matches a signature in the signature file, having the wireless device authenticate to the given network server; and
if the signature associated with the given authentication protocol does not match a signature in the signature file, taking a given action.

2. The method as described in claim 1 further including the step of updating the signature file with a new signature.

3. The method as described in claim 2 wherein the new signature is associated with an authentication protocol for a network access server that has been added to the set of network access servers.

4. The method as described in claim 2 wherein the signature file is updated without requiring re-compilation of client code on the wireless device.

5. The method as described in claim 1 wherein the given action includes the steps of:
having the wireless device authenticate to the network access server using an unknown authentication protocol;
generating a signature associated with the unknown authentication protocol; and
updating the signature file to include the signature associated with the unknown authentication protocol.

6. The method as described in claim 1 wherein the step of generating the signature is performed in an off-line data gathering process.

7. The method as described in claim 1 wherein the signature includes a character string that uniquely identifies a given entity.

8. The method as described in claim 1 wherein the signature includes a character string associated with an authentication procedure.

9. The method as described in claim 1 wherein the signature includes a character string associated with an authentication result.

10. The method as described in claim 1 wherein the signature includes a character string associated with a logoff procedure.

11. The method as described in claim 1 wherein the signature includes a character string associated with a logoff result.

12. In a wireless device having a client component that performs automated user authentication in a wireless local area network (WLAN) environment, the improvement comprising:
a signature file having a set of signatures, wherein each signature is uniquely associated with an authentication protocol used by a network access server in the WLAN environment; and
code, responsive to an attempt by the wireless device to authenticate to a given network server using a given authentication protocol, to determine whether a signature associated with the given authentication protocol matches a signature in the signature file.

13. In the wireless device as described in claim 12, further including:
code, responsive to a match between the signature associated with the given authentication protocol and a signature in the signature file, for enabling the wireless device to authenticate to the given network server; and
code, responsive to a failure to match the signature associated with the given authentication protocol and a signature in the signature file, for updating the signature file with a new signature that is generated as the wireless device authenticates to the given network server.

14. In the wireless device as described in claim 12, further including:
code for updating the signature file with a new signature.

15. In the wireless device as described in claim 14 wherein the signature file is updated without requiring re-compilation of the client component on the wireless device.
